(19) United States
(12) Patent Application Publication
(10) Pub. No.: US 2008/0192504 A1
(43) Pub. Date: Aug. 14, 2008

(54) Backlight module

(75) Inventor: Fang-I Chou, Yangmei Taoyuan (TW)

Correspondence Address: TROXELL LAW OFFICE PLLC, SUITE 1404, 5205 LEESBURG PIKE, FALLS CHURCH, VA, 22041, US

(73) Assignee: K-Bridge Electronics Co., Ltd.

(21) Appl. No.: 11/812,356

(22) Filed: Jun. 18, 2007

(30) Foreign Application Priority Data
Feb. 9, 2007 (TW) 096202532

(51) Int. Cl. F21V 7/04; F21V 7/05

(52) U.S. Cl. 362/612; 362/615

(57) ABSTRACT

A backlight module including light guide plate, light source disposed facing a light-in surface of the light guide plate, and optical film; both of bottom surface and light-out surface of the light guide plate being respectively disposed with a same type or two different types of a dimming structure to change traveling routes of streams of light emitted from the light source upon entering into the light guide plate through the dimming structure without developing bright-dark-bright bands so to achieve illumination uniformity performance of the light source.

### BACKGROUND OF THE INVENTION

(a) Field of the Invention

The present invention is related to a backlight, and more particularly, to one that more effectively distribute streams of light from light source by preventing developing bright-dark-bright bands.

(b) Description of the Prior Art

Depending on requirements of practical design, a bottom or an edge emitting backlight module configuration is elected for a liquid crystal display generally applied in information installation. FIG. 1 of the accompanying drawings shows a schematic view of a basic construction of an edge emitting backlight module. As illustrated in FIG. 1, the edge emitting backlight module is comprised of a light guide plate (LGP) 21, a light source 22 disposed on an edge of the LGP 21, a reflective film 23 disposed beneath the LGP 21, and multiple optical films disposed between the LGP 21 and a display panel 27.

Wherein, the primary function of the LGP 21 is to convert parallel streams of light emitted from the light source into plane vertical ones by working on the principle of optical scattering. However, to achieve illumination uniformity results of the scattering, multiple optical films are usually disposed between the LGP 21 and the display panel 27 essentially in the sequence of a lower diffusion sheet 24, two brightness enhancement films 25, and an upper diffusion sheet 26. Addition of multiple optical films not only increases production cost but also compromise requirements of being compact.

In a construction of another prior art as illustrated in FIG. 1(B), the LGP 21 has on one side disposed with a dimming structure. As illustrated, the LGP 21 is provided with a light-in surface 211 to receiving incoming streams of light, a bottom surface 212 intersecting with the light-in surface 211, and a light-out surface opposite to the bottom surface 212. Wherein, the light-out surface 213 is comprised of multiple microstructures 214; when streams of light emitted from the light source 22 enters into the LGP 21 and are diffused at greater angles through reflection by those microstructures 213 provided on the light-out surface 213. However, reflection by those microstructures 214 for being related to a single refection only provides light diffusion results and fails to achieve the purpose of illumination uniformity.

### SUMMARY OF THE INVENTION

The primary purpose of the present invention is to provide a backlight module that effectively solves the problem of developing bright-dark-bright bands found with the prior art.

To achieve the purpose, the present invention includes a light guide plate, a light source disposed in facing a light-in surface of the light guide plate, and optical film. Wherein, a bottom surface and a light-out surface of the light guide plate are respectively provided with a dimming structure. Both dimming structures may be of a same type or of two different types to change traveling routes of streams of light upon entering into the light guide plate to prevent from developing bright-dark-bright bands so to achieve performance of illumination uniformity for the light source.

### BRIEF DESCRIPTION OF THE DRAWINGS

FIG. 1(A) is a perspective view of a construction of an edge emitting backlight module of the prior art.

FIG. 1(B) is a schematic view showing traveling routes of streams of light in an edge emitting backlight module of another prior art.

FIG. 2(A) is a schematic view showing a construction of a first preferred embodiment of an edge emitting backlight module of the present invention.

FIG. 2(B) is a schematic view showing traveling routes of streams of light in the first preferred embodiment of the present invention.

FIG. 3 is a schematic view showing a construction of a second preferred embodiment of the edge emitting backlight module of the present invention.

FIGS. 4(A) and 4(B) are schematic views showing different constructions of a third preferred embodiment of the edge emitting backlight module of the present invention.

FIGS. 5(A) and 5(B) are schematic views showing different constructions of a fourth preferred embodiment of the edge emitting backlight module of the present invention.

FIGS. 6(A) and 6(B) are schematic views showing different constructions of a fifth preferred embodiment of the edge emitting backlight module of the present invention.

### DETAILED DESCRIPTION OF THE PREFERRED EMBODIMENTS

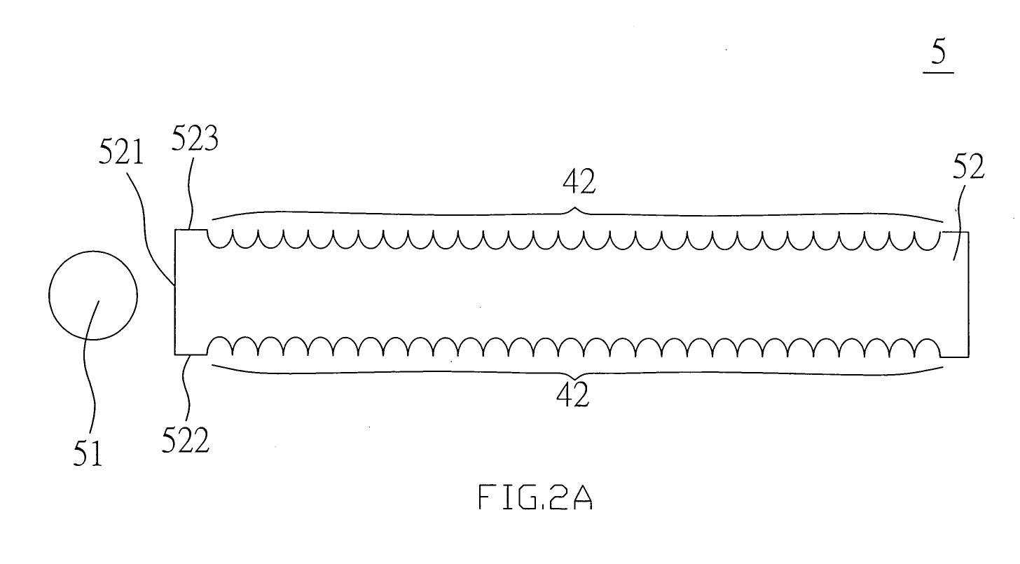

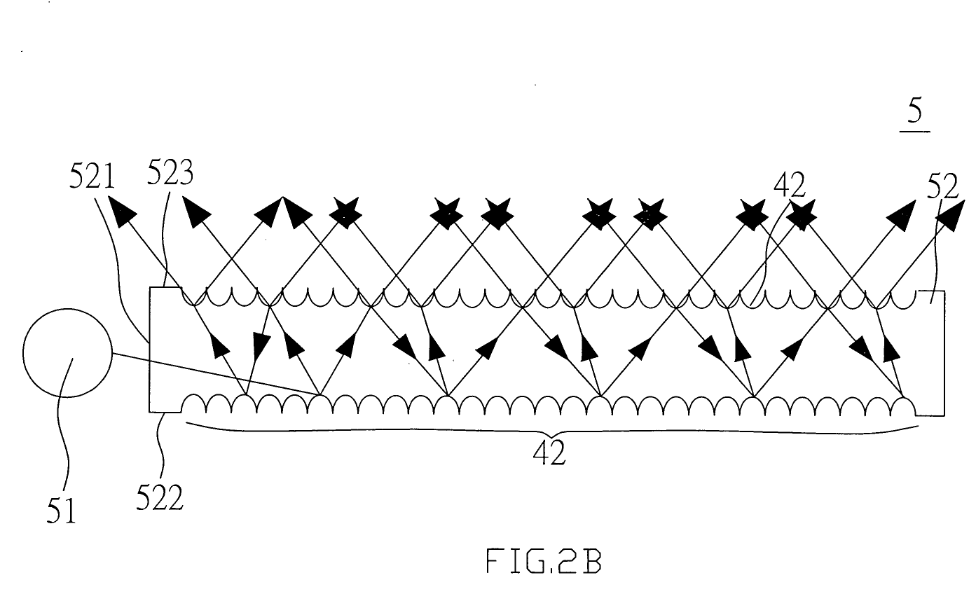

Referring to FIG. 2(A), a backlight module according to the present invention includes a light source 51 and a light guide plate 52. The light guide plate 52 is disposed with a light-in surface 521 to receive incoming streams of light, a bottom surface 522 intersecting with the light-in surface 521, and a light-out surface 523 opposite to the bottom surface 522. The light source 51 is disposed facing the light-in surface 521 of the light guide plate 52. The light source may be related to a tube or a light emitting diode, and the latter is used in the preferred embodiment. Streams of light emitted from the light source 51 are radiated from the light-out surface 523 of the light guide plate 52 to achieve the expected performance of the light source 51.

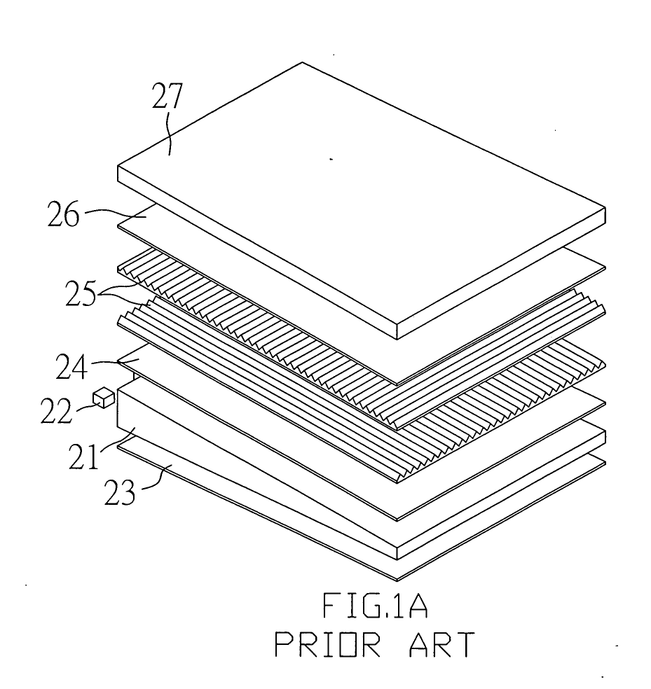

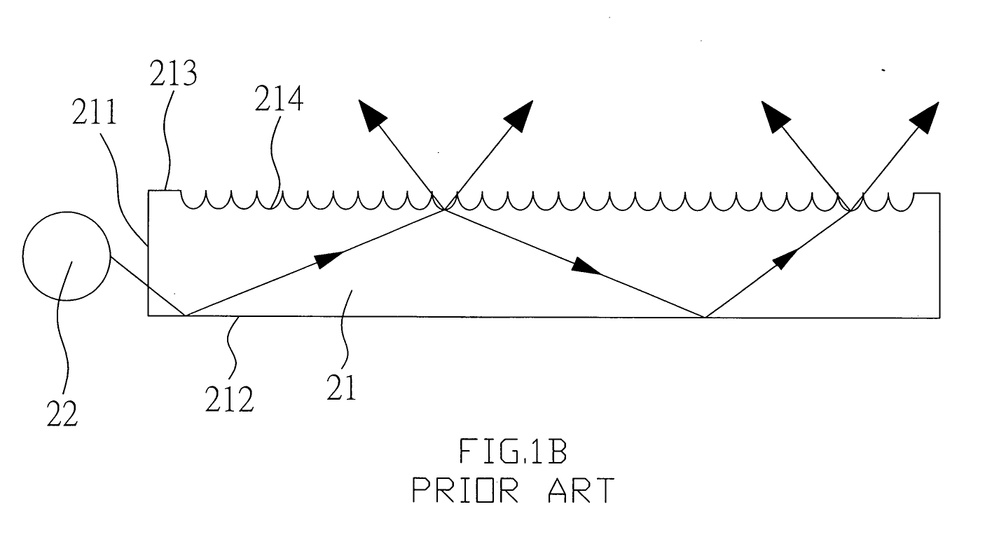

Both of the bottom surface 522 and the light-out surface 523 of the light guide plate 52 are respectively disposed with a same type or two different types of a dimming structure integrated with the light guide plate 52 and may be comprised of multiple grooves or dots. As illustrated, both of the bottom surface 522 and the light-out surface are each disposed with a dimming structure comprised of multiple U-shaped grooves 42. When streams of light emitted from the light source enter into the light-in surface 521 of the light guide plate 52, they are reflected for the first time by those U-shaped grooves 42 disposed on the bottom surface 521 of the light guide plate 52 as also illustrated in FIG. 2(B) to be dissipated. Those streams of light after having been reflected for the first time are partially reflected for the second time by those U-shaped grooves 42 disposed on the light-out surface 523 while the remaining streams of light are reflected to the bottom surface 522 to be further reflected again. Accordingly, traveling routes of those streams of light are changed without developing bright-dark-bright bands to provide better scattering illumination uniformity results than those routes illustrated in FIG. 1(B) of the prior art.

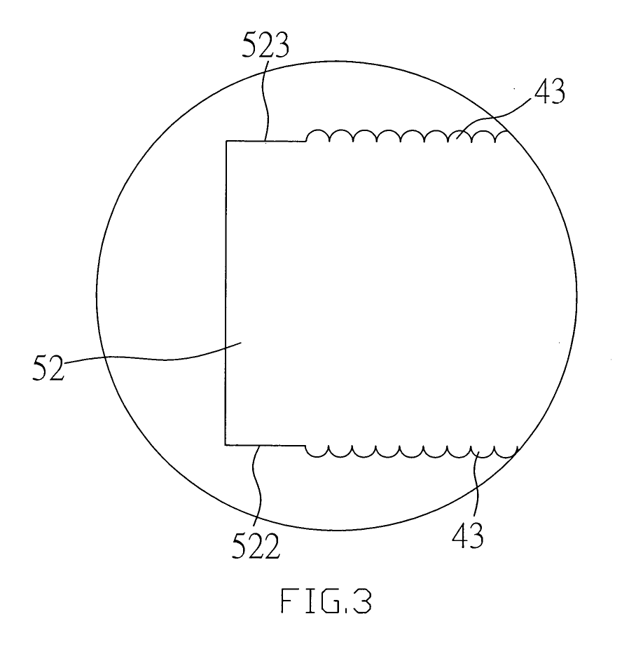

Now referring to FIG. 3 for a second preferred embodiment of the present invention, the bottom surface 522 and the light-out surface 523 are each provided with a dimming structure comprised of multiple dots 43.

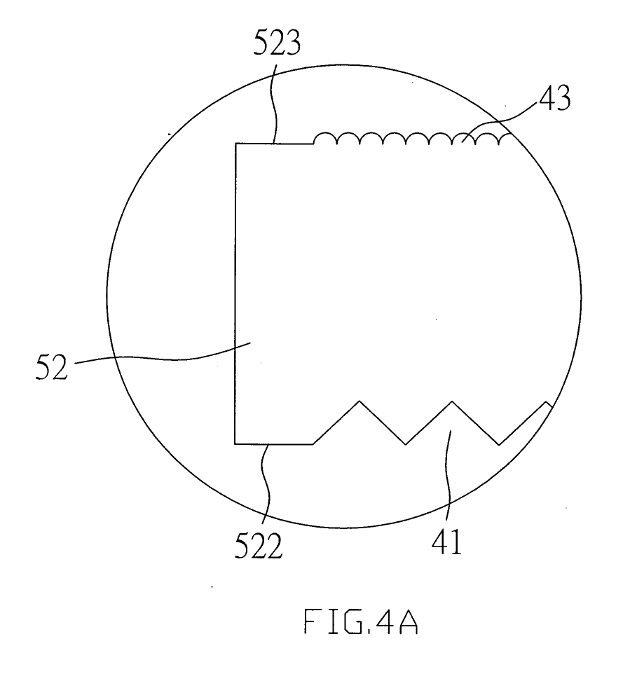

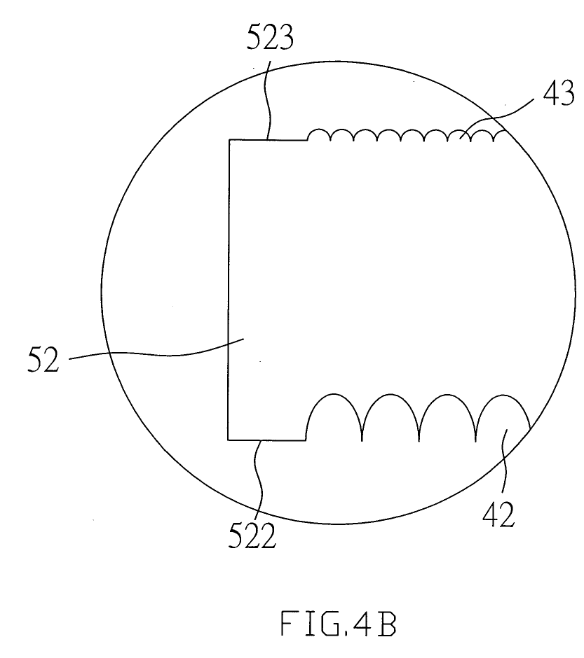

As illustrated in FIG. 4(A) for a third preferred embodiment of the present invention, the bottom surface 522 is disposed with a dimming structure comprised of multiple V-shaped grooves 41 while the light-out surface 523 is disposed with another dimming structure comprised of multiple dots 43; or alternatively as illustrated in FIG. 4(B), the bottom surface 522 is disposed with a dimming structure comprised of multiple U-shaped grooves 42 while the light-out surface 523 is disposed with another dimming structure comprised of multiple dots 43.

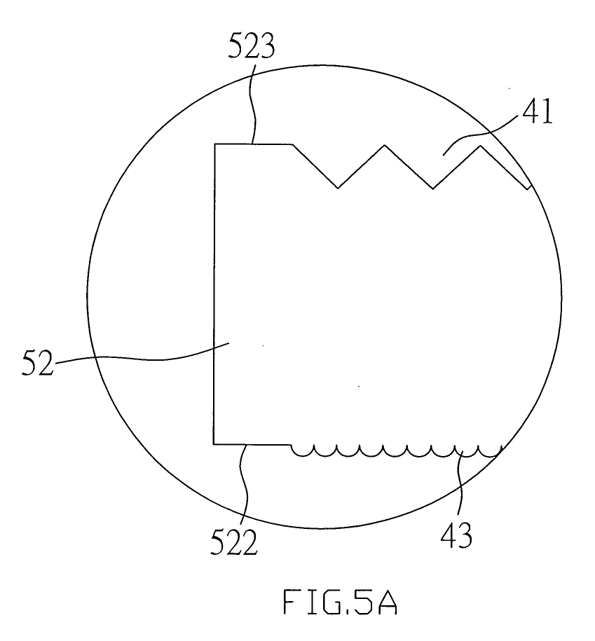

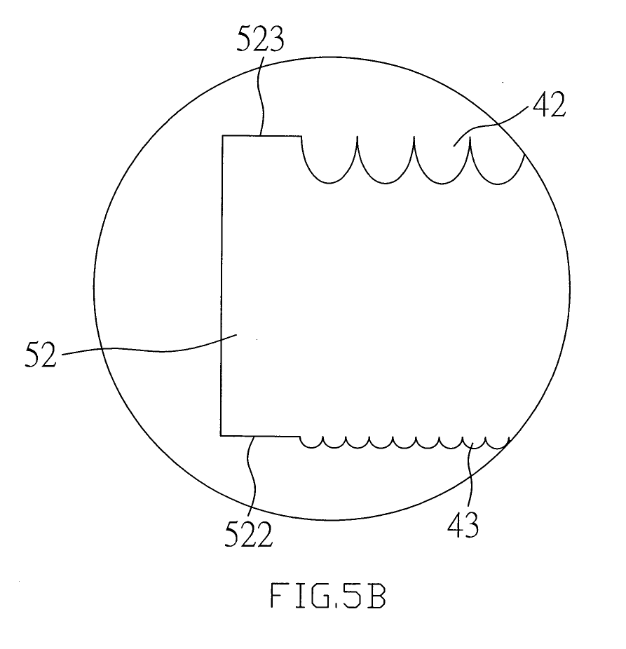

In a fourth preferred embodiment of an edge emitting backlight module of the present invention as illustrated in FIG. 5(A), the bottom surface is disposed with a dimming structure comprised of multiple dots 43 while the light-out surface 523 is disposed with another dimming structure comprised of multiple V-shaped grooves 41; or alternatively as illustrated in FIG. 5(B), the bottom surface 522 is disposed with a dimming structure comprised of multiple dots 43 while the light-out surface 523 is disposed with another dimming structure comprised of multiple U-shaped grooves 42.

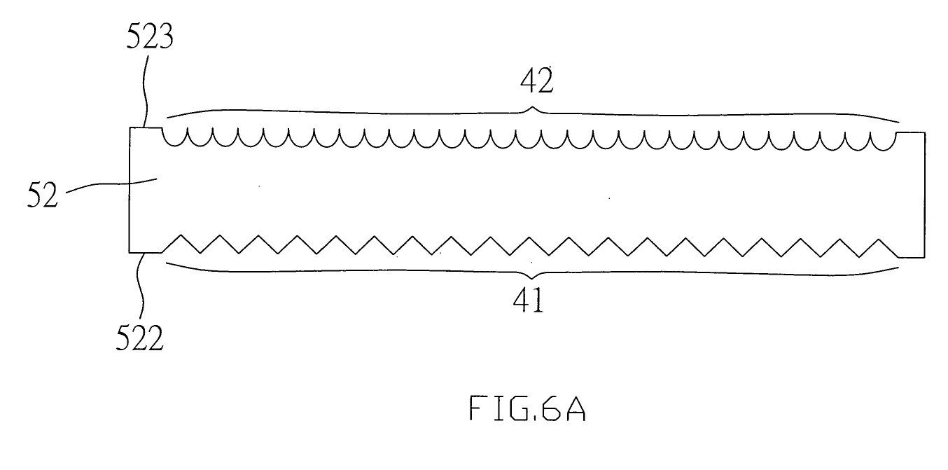

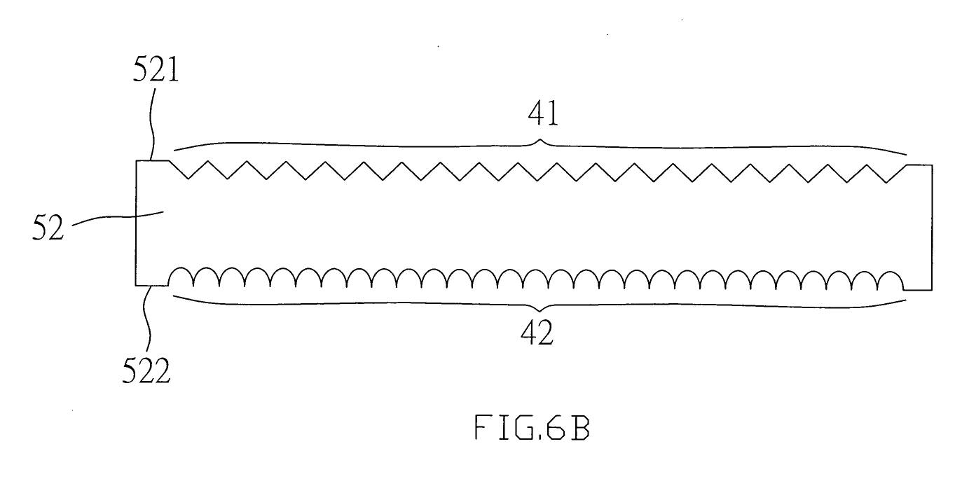

In a fifth preferred embodiment of an edge emitting backlight module of the present invention as illustrated in FIG. 6(A), the bottom surface 522 is disposed with a dimming structure comprised of multiple V-shaped grooves 41 while the light-out surface 523 is disposed with another dimming structure comprised of multiple U-shaped grooves 42; or alternatively as illustrated in FIG. 6(B), the bottom surface 522 is disposed with a dimming structure comprised of multiple U-shaped grooves 42 while the light-out surface 523 is disposed with another dimming structure comprised of multiple V-shaped grooves 41.

The prevent invention provides an improved structure of a backlight module, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A backlight module comprising a light guide plate and a light source; the light guide plate being disposed with a light-in surface to receive incoming streams of light, a bottom surface intersecting the light entrance surface, and a light emitting surface disposed opposite to the light entrance surface, two identical dimming structures being respective provided to the bottom surface and the light emitting surface of the light guide plate, and each dimming structure being comprised of multiple grooves; and the light source being disposed at where it faces the light-in surface of the light guide plate.

2. The backlight module as claimed in claim 1, wherein each of those grooves is related to a V-shaped or U-shaped groove.

3. The backlight module as claimed in claim 1, wherein the light source is related to a tube or a light emitting diode.

4. The backlight module as claimed in claim 1, wherein the dimming structure and the light guide plate are made in an integral part.

5. A backlight module comprising a light source and a light guide plate, a light-in surface being provided to the light guide plate to receive incoming streams of light, a bottom surface intersecting with the light-in surface, and a light-out surface opposite to the bottom surface; both of the bottom surface and the light-out surface of the light guide plate being respectively disposed with an identical type of dimming structure; the dimming structure each disposed to the bottom surface and the light-out surface being related to a structure of multiple dots; and a light source is disposed at where in facing the light-in surface of the light guide plate.

6. The backlight module as claimed in claim 5, wherein the light source is related to a tube or a light emitting diode.

7. The backlight module as claimed in claim 5, wherein the dimming structure and the light guide plate are made in an integral part.

8. A backlight module comprising a light guide plate and a light source; the light guide plate being disposed with a light-in surface to receive incoming streams of light, a bottom surface intersecting the light entrance surface, and a light-out surface disposed opposite to the light entrance surface, two different types of dimming structure being respectively provided to the bottom surface and the light-out surface of the light guide plate, and the dimming structure disposed to the bottom surface being comprised of multiple grooves or dots, and another dimming structure disposed to the light-out surface being comprised of multiple dots or grooves; and the light source being disposed at where it faces the light-in surface of the light guide plate.

9. The backlight module as claimed in claim 8, wherein the each of those grooves is related to a V-shaped or U-shaped groove.

10. The backlight module as claimed in claim 8, wherein the light source is related to a tube or a light emitting diode.

11. The backlight module as claimed in claim 8, wherein the dimming structure and the light guide plate are made in an integral part.
